(19) United States
(12) Patent Application Publication
(10) Pub. No.: US 2025/0124826 A1
(43) Pub. Date: Apr. 17, 2025

(54) SIGN ASSEMBLY

(71) Applicant: Fourth Wall Industries, LLC, Marietta, GA (US)

(72) Inventor: Walter Thompson, Marietta, GA (US)

(21) Appl. No.: 18/773,092

(22) Filed: Jul. 15, 2024

Related U.S. Application Data
(60) Provisional application No. 63/543,610, filed on Oct. 11, 2023.

(51) Int. Cl. G09F 7/18; E01F 9/654; E01F 9/658

(52) U.S. Cl. CPC G09F 7/18; E01F 9/654; E01F 9/658; G09F 2007/1856; G09F 2007/1878

(57) ABSTRACT

A sign assembly can include a traffic cone; a sign; and a mounting assembly including a top coupler coupled to the sign; a top ring coupled to the top coupler, the top ring positioned around an upright portion of the traffic cone; a bottom coupler coupled to the sign; and a bottom ring coupled to the bottom coupler, the bottom ring positioned around the upright portion.

### TECHNICAL FIELD

This application claims the benefit of U.S. Provisional Application No. 63/543,610, filed Oct. 11, 2023, which is hereby specifically incorporated by reference herein in its entirety.

### TECHNICAL FIELD

This disclosure relates to a sign assembly. More specifically, this disclosure relates to a sign assembly utilizing a traffic cone.

### BACKGROUND

Temporary signage is commonly used for events and field operations to direct traffic and manage parking, which may be altered or disrupted by the event or operation. For example, concerts, fairs, on-site filming, and/or construction may block travel routes or require the establishment of additional parking areas.

In some instances, signs are attached to traffic cones to provide temporary signage, often using non-reusable fasteners such as zip ties, which have to be cut off and disposed of after each use. Zip ties are often threaded through holes punched in the signs and then strapped to the traffic cones, which also tends to damage the signs. Damage to the signs can be exacerbated by environmental conditions, such as high winds, which can cause the signs to tear near the holes and shorten the useful life of the signs. The signs can also be difficult to mount in unfavorable conditions, such as in the dark or in windy conditions.

### SUMMARY

It is to be understood that this summary is not an extensive overview of the disclosure. This summary is exemplary and not restrictive, and it is intended to neither identify key or critical elements of the disclosure nor delineate the scope thereof. The sole purpose of this summary is to explain and exemplify certain concepts of the disclosure as an introduction to the following complete and extensive detailed description.

Disclosed is a sign assembly comprising a traffic cone; a sign; and a mounting assembly comprising a top coupler coupled to the sign; a top ring coupled to the top coupler, the top ring positioned around an upright portion of the traffic cone; a bottom coupler coupled to the sign; and a bottom ring coupled to the bottom coupler, the bottom ring positioned around the upright portion.

Also disclosed is a mounting assembly for mounting a sign to a traffic cone, the mounting assembly comprising a first coupler configured to couple to the sign; a first ring coupled to the first coupler, the first ring sized to fit around an upright portion of the traffic cone; a second coupler configured to couple to the sign; and a second ring coupled to the second coupler, the second ring sized to fit around the upright portion.

Various implementations described in the present disclosure may include additional systems, methods, features, and advantages, which may not necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims. The features and advantages of such implementations may be realized and obtained by means of the systems, methods, features particularly pointed out in the appended claims. These and other features will become more fully apparent from the following description and appended claims, or may be learned by the practice of such exemplary implementations as set forth hereinafter.

### BRIEF DESCRIPTION OF THE DRAWINGS

The features and components of the following figures are illustrated to emphasize the general principles of the present disclosure. The drawings are not necessarily drawn to scale. Corresponding features and components throughout the figures may be designated by matching reference characters for the sake of consistency and clarity.

FIG. 1 is front view of a sign assembly comprising a mounting assembly, a traffic cone, and a sign in accordance with one aspect of the present disclosure.

FIG. 2 is a rear view of the sign assembly of FIG. 1.

FIG. 3 is a side view of the mounting assembly and the traffic cone of FIG. 1.

FIG. 4 is a top view of the mounting assembly of FIG. 1.

FIG. 5 is a detail side view of a top coupler and a top ring of the mounting assembly installed on the traffic cone of FIG. 1.

FIG. 6 is a perspective side view of the top ring of FIG. 1 and another aspect of the top coupler installed on the traffic cone of FIG. 1.

FIG. 7 is a detail view of a bottom coupler and a bottom ring of the mounting assembly installed on the traffic cone of FIG. 1.

FIG. 8 is a rear view of the mounting assembly coupled to the sign of FIG. 1.

FIG. 9 is a rear perspective view of the mounting assembly coupled to the sign of FIG. 1.

FIG. 10 is a rear perspective view of the mounting assembly and sign being installed by a user on the traffic cone of FIG. 1.

FIG. 11 is a rear perspective view of the sign assembly of FIG. 1 with the sign in a vertical orientation.

FIG. 12 is a front view of the sign assembly of FIG. 1 with the sign placed in a horizontal orientation.

FIG. 13 is a perspective view of an adjustable ring of another aspect of the mounting assembly.

FIG. 14 is a top view of another aspect of the adjustable ring.

FIG. 15 is a perspective view of another aspect of the adjustable ring.

FIG. 16 is a perspective view of another aspect of the adjustable ring.

FIG. 17 is a perspective view of the traffic cone of FIG. 1 and another aspect of the mounting assembly.

FIG. 18 is a perspective view of the traffic cone of FIG. 1 and the mounting assembly of FIG. 17.

FIG. 19 is a perspective view of the traffic cone of FIG. 1 and the mounting assembly of FIG. 17.

FIG. 20 is a rear view of the sign assembly comprising the mounting assembly of FIG. 17 and the traffic cone and the sign of FIG. 1.

FIG. 21 is a top view of two adjustable rings in accordance with another aspect of the present disclosure.

FIG. 22 is a top view of two adjustable rings in accordance with another aspect of the present disclosure.

FIG. 23 is a detailed view of another aspect of the bottom coupler and the bottom ring in accordance with another aspect of the present disclosure.

FIG. 24 is a front view of another aspect of a coupler in accordance with another aspect of the present disclosure.

FIG. 25 is a rear view of the coupler of FIG. 24.

FIG. 26 is a top view of two adjustable rings in accordance with another aspect of the present disclosure.

FIG. 27 is a perspective view of the adjustable rings of FIG. 26 mounted on another aspect of a traffic cone in accordance with another aspect of the present disclosure.

FIG. 28 is a perspective view of the adjustable rings of FIG. 26 mounted on the traffic cone of FIG. 27 and another aspect of the sign.

FIG. 29 is a top view of the adjustable rings of FIG. 26 coupled to the sign of FIG. 28.

### DETAILED DESCRIPTION

The present disclosure can be understood more readily by reference to the following detailed description, examples, drawings, and claims, and the previous and following description.

It is also to be understood that the terminology used herein is for the purpose of describing particular aspects only and is not intended to be limiting.

The following description is provided as an enabling teaching of the present devices, systems, and/or methods in its best, currently known aspect. To this end, those skilled in the relevant art will recognize and appreciate that many changes can be made to the various aspects of the present devices, systems, and/or methods described herein, while still obtaining the beneficial results of the present disclosure. It will also be apparent that some of the desired benefits of the present disclosure can be obtained by selecting some of the features of the present disclosure without utilizing other features. Accordingly, those who work in the art will recognize that many modifications and adaptations to the present disclosure are possible and can even be desirable in certain circumstances and are a part of the present disclosure. Thus, the following description is provided as illustrative of the principles of the present disclosure and not in limitation thereof.

As used throughout, the singular forms “a,” “an” and “the” include plural referents unless the context clearly dictates otherwise. Thus, for example, reference to “a resistor” can include two or more such resistors unless the context indicates otherwise.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

For purposes of the current disclosure, a material property or dimension measuring about X or substantially X on a particular measurement scale measures within a range between X plus an industry-standard upper tolerance for the specified measurement and X minus an industry-standard lower tolerance for the specified measurement. Because tolerances can vary between different materials, processes and between different models, the tolerance for a particular measurement of a particular component can fall within a range of tolerances.

As used herein, the terms “optional” or “optionally” mean that the subsequently described event or circumstance can or cannot occur, and that the description includes instances where said event or circumstance occurs and instances where it does not.

The word “or” as used herein means any one member of a particular list and also includes any combination of members of that list. Further, one should note that conditional language, such as, among others, “can,” “could,” “might,” or “may,” unless specifically stated otherwise, or otherwise understood within the context as used, is generally intended to convey that certain aspects include, while other aspects do not include, certain features, elements and/or steps. Thus, such conditional language is not generally intended to imply that features, elements and/or steps are in any way required for one or more particular aspects or that one or more particular aspects necessarily include logic for deciding, with or without user input or prompting, whether these features, elements and/or steps are included or are to be performed in any particular aspect.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific aspect or combination of aspects of the disclosed methods.

In one aspect, disclosed is a sign assembly and associated methods, systems, devices, and various apparatus. The sign assembly can comprise a mounting assembly, a traffic cone, and a sign. It would be understood by one of skill in the art that the disclosed sign assembly is described in but a few exemplary aspects among many. No particular terminology or description should be considered limiting on the disclosure or the scope of any claims issuing therefrom.

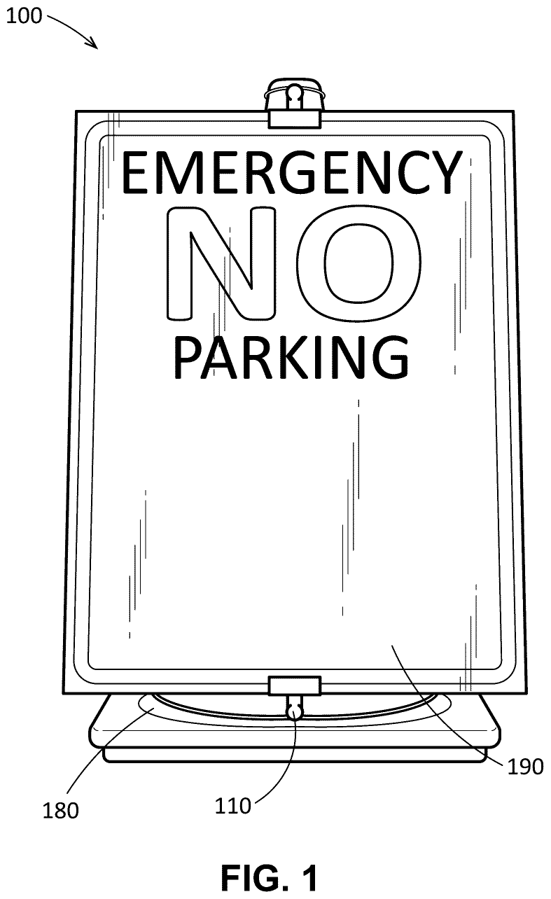

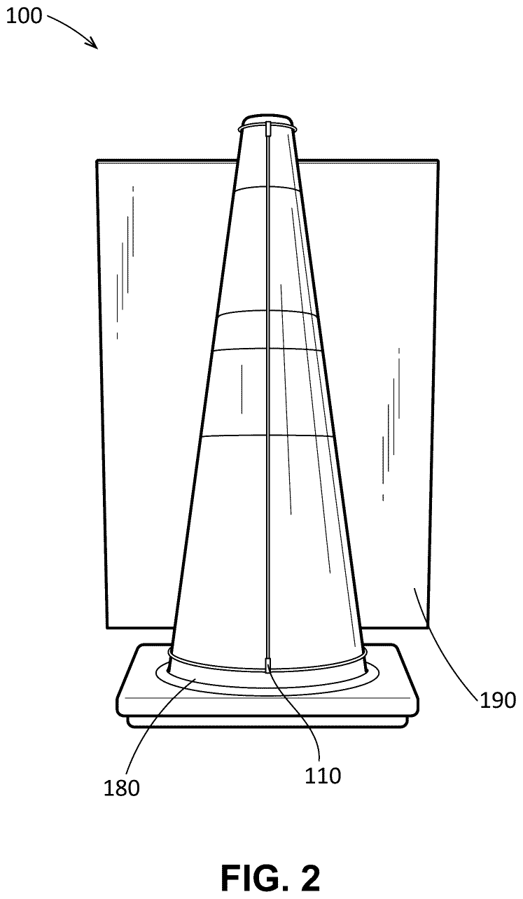

FIG. 1 is a front view of one aspect of a sign assembly 100 in accordance with the present disclosure, and FIG. 2 is a rear view of the sign assembly 100 of FIG. 1. The sign assembly 100 can comprise a mounting assembly 110, a traffic cone 180, and a sign 190. As described in greater detail below, the mounting assembly 110 can couple to the traffic cone 180 and to the sign 190, which can secure the sign 190 to the traffic cone 180. The term “traffic” should not be viewed as limiting, as the traffic cones 180 can be utilized for any purpose, including those unrelated to traffic.

The sign 190 can comprise corrugated cardboard, corrugated plastic, posterboard, metal, plastic, ceramic, paper, or any other suitable material. The sign 190 can be rigid or flexible. For example and without limitation, the sign 190 can be a board in some aspects. In some aspects, the sign 190 can define indicia, such as one or more words, symbols, designs, or other markings, or combinations thereof. In some aspects, the sign 190 can comprise a plurality of structures. For example and without limitation, the sign 190 can comprise a board and one or more posters, stickers, or combinations thereof coupled to the board.

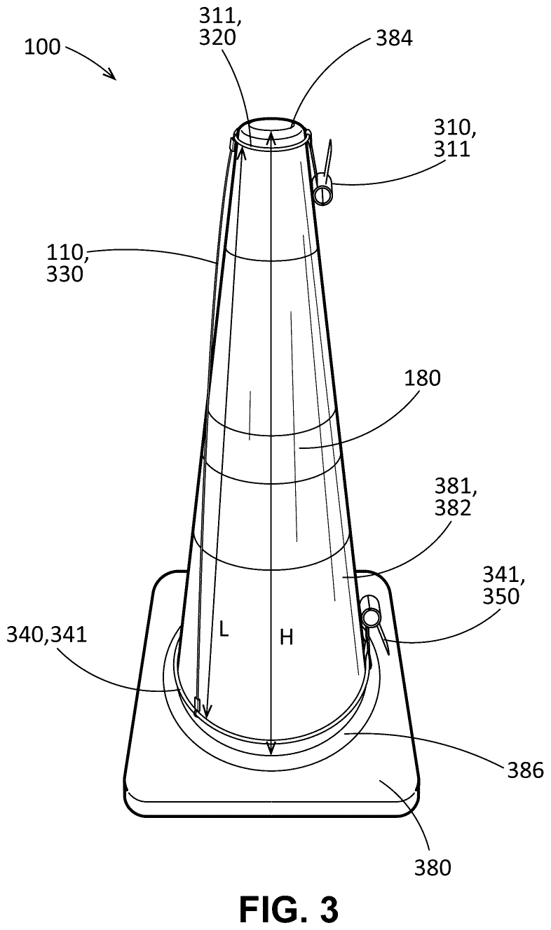

FIG. 3 is a side view of the sign assembly 100 of FIG. 1 with the sign 190 removed. The traffic cone 180 can comprise a base 380 and an upright portion 381. In some aspects, the upright portion 381 can be a conical portion 382. The conical portion 382 can define a conical or frustoconical shape. The upright portion 381 and/or the conical portion 382 can define a top end 384 and a bottom end 386. The bottom end 386 can be coupled to the base 380. The conical portion 382 can taper from the bottom end 386 towards the top end 384 such that a diameter of the top end 384 can be smaller than a diameter of the bottom end 386.

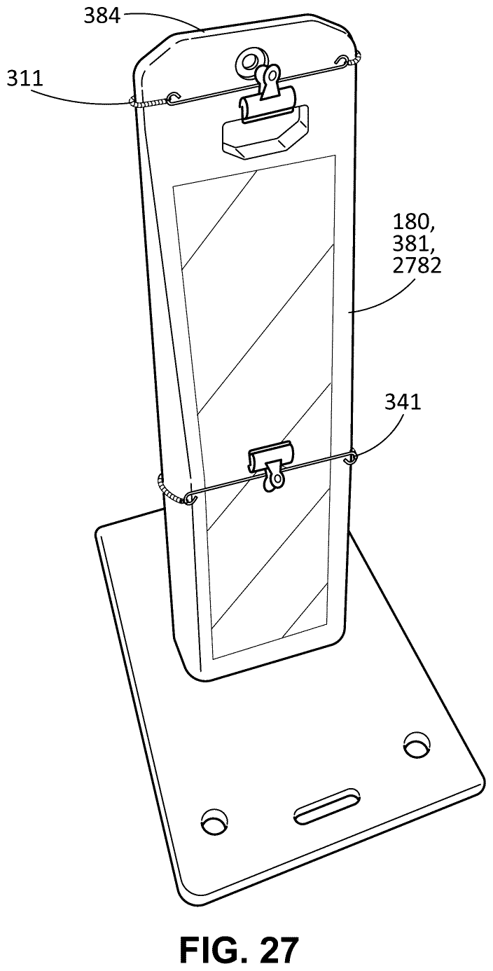

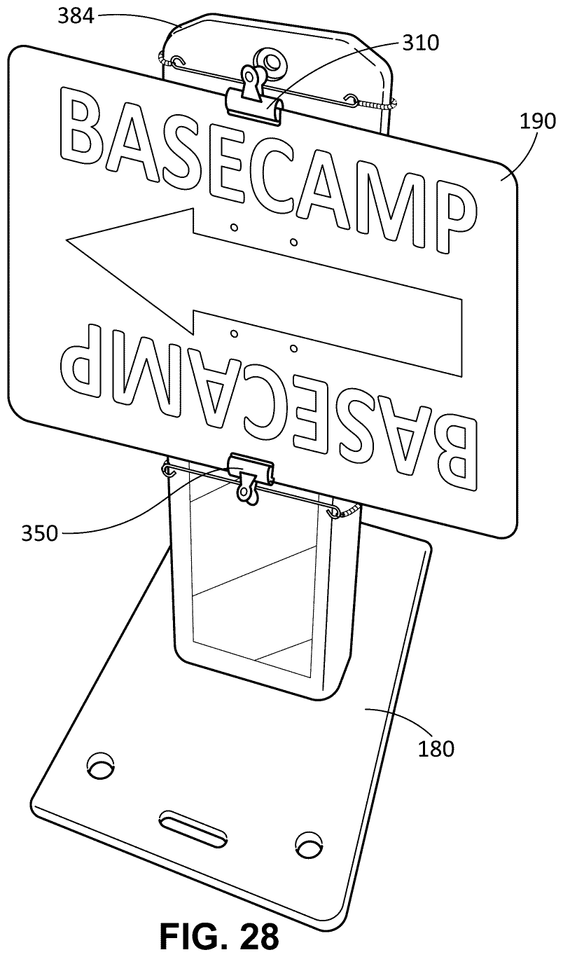

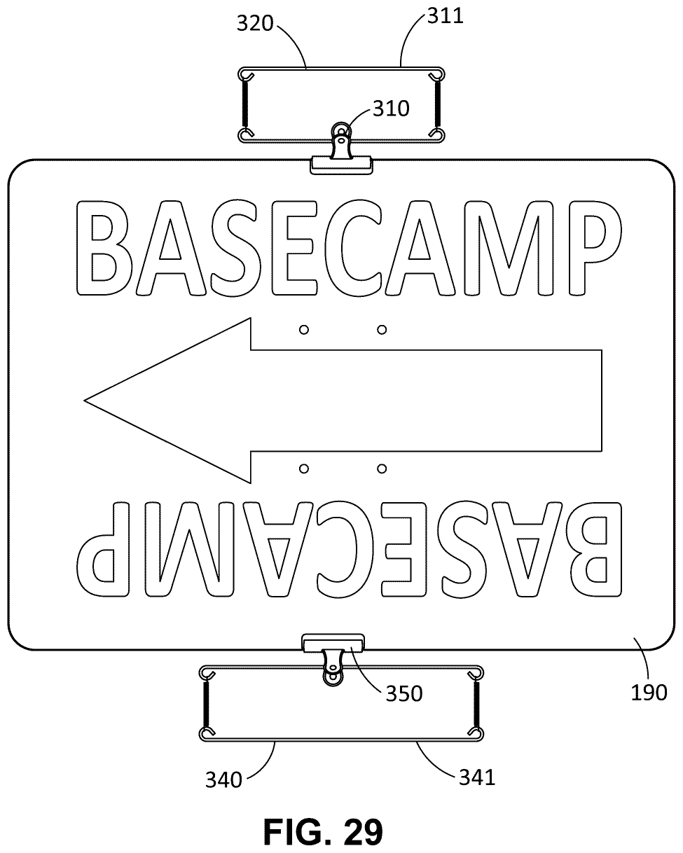

The shape of the traffic cone 180 should not be viewed as limiting. In various aspects, the sign assembly 100 can comprise traffic cones 180 of various sizes and shapes, including traffic cones with a cylindrical portion, a pyramidal portion (see FIGS. 27-28), or any other suitable shape.

The mounting assembly 110 can comprise a top coupler 310, a top ring 320, a bottom ring 340, and a bottom coupler 350. The top coupler 310 and the top ring 320 can together define a top coupling ring 311. The bottom ring 340 and the bottom coupler 350 can together define a bottom coupling ring 341. The mounting assembly 110 can optionally comprise a link 330 in some aspects. The top coupler 310 can be coupled to the top ring 320. The link 330 can be coupled to each of the top ring 320 and the bottom ring 340. The bottom coupler 350 can be coupled to the bottom ring 340. In the present aspect, the link 330 can be coupled to each ring 320,340 on the opposite side from each respective coupler 310,350. In some aspects, the link 330 can couple to the top ring 320 and/or the bottom ring 340. In some aspects, the link 330 can couple to the top coupler 310 and/or the bottom coupler 350.

A length L of the link 330 can be approximately equal to a height H of the upright portion 381, such as the conical portion 382 in the aspect shown, as measured between the top end 384 and the bottom end 386. In some aspects, the length L of the link 330 can be adjustable for use with traffic cones 180 and/or signs 190 (shown in FIG. 1) of different dimensions. In some aspects, the traffic cone 180 can be a 28″ traffic cone or a 36″ traffic cone, though these dimensions should not be viewed as limiting. In some aspects, the sign can be a 24-inch×18-inch sign, though this size should not be viewed as limiting.

The top ring 320 can be sized to fit at or near the top end 384 of the conical portion 382, and the bottom ring 340 can be sized to fit at or near the bottom end 386 of the conical portion 382.

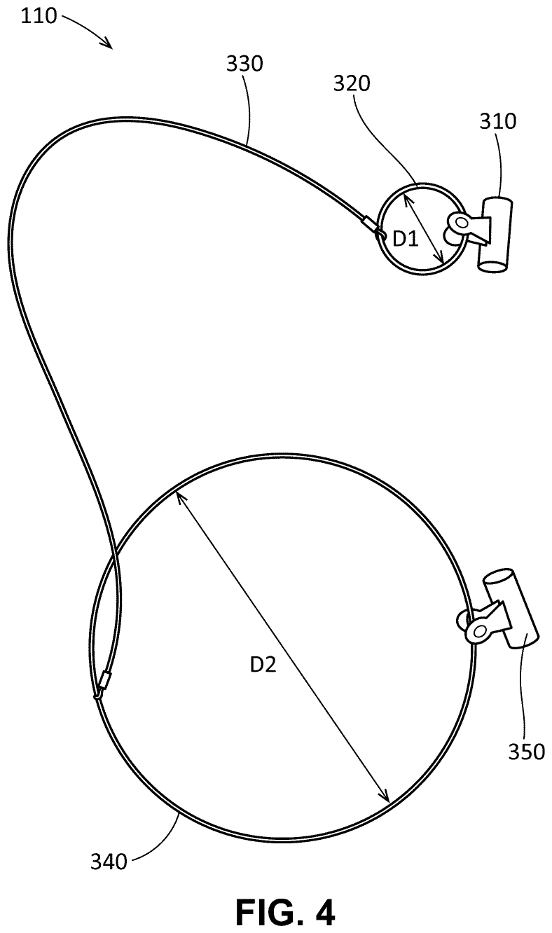

As shown in FIG. 4, the top ring 320 can define an inner diameter D1, and the bottom ring 340 can define an inner diameter D2.

In some aspects, the inner diameter D1 can be 1 to 4 inches in size. In some aspects, the inner diameter D1 can be 1½ to 3 inches in size. In some aspects, the inner diameter D1 can have a value between 1⅞ to 2¾ inches. In some aspects, the inner diameter D1 can be smaller than 1 inch or larger than 4 inches.

In some aspects, the inner diameter D2 can be 7 to 12 inches in size. In some aspects, the inner diameter D2 can be 8 to 11 inches in size. In some aspects, the inner diameter D2 can be 8 ½ to 10½ inches. In some aspects, the inner diameter D2 can be smaller than 7 inches or larger than 12 inches.

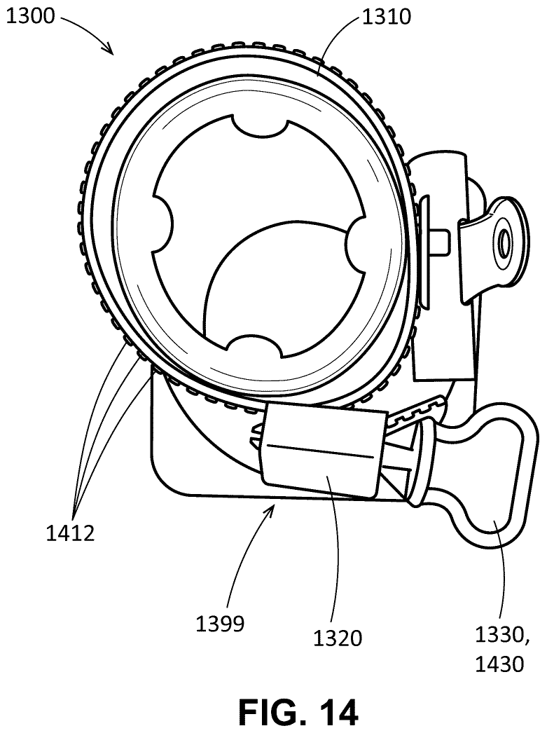

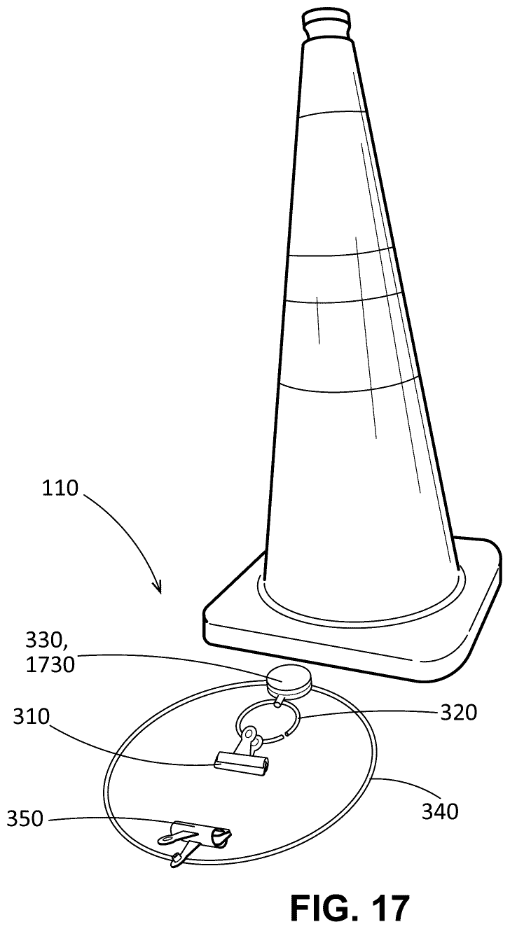

In some aspects, the top ring 320 and/or the bottom ring 340 can be a hoop that can be either closed (as shown) or open (see top ring 320 in FIG. 17). In particular, open hoops, such as those with a small gap in the perimeter, can provide some variability to the respective inner diameters D1,D2 as open hoops can stretch to fit around a larger object. In some aspects, the top ring 320 and/or the bottom ring 340 can be a flexible loop, such as one made of webbing, straps, cloth, string, elastic, or other suitable materials. For example and without limitation, in some aspects, the top ring 320 and/or the bottom ring 340 can be a spring, such as a garter spring or any other suitable type of spring. The top ring 320 and the bottom ring 340 can define rigid materials, such as a metal, polymer, wood, or other suitable materials, for example and without limitation. As discussed in greater detail below with respect to FIGS. 14-17, in some aspects, the top ring 320 and the bottom ring 340 can be adjustable in size, which can increase or decrease the respective inner diameters D1,D2 to accommodate traffic cones 180 of varying shapes and sizes or to alter the position at which the rings 320,340 rest on the traffic cone 180.

As demonstrated, the link 330 can be a flexible piece of material in the aspect shown, such as a rope, wire, strap, webbing, cord, cable, elastic band, or other suitable material. In some aspects, the link 330 can be rigid, such as a board, stick, pole, rod, beam, tube, or other suitable member.

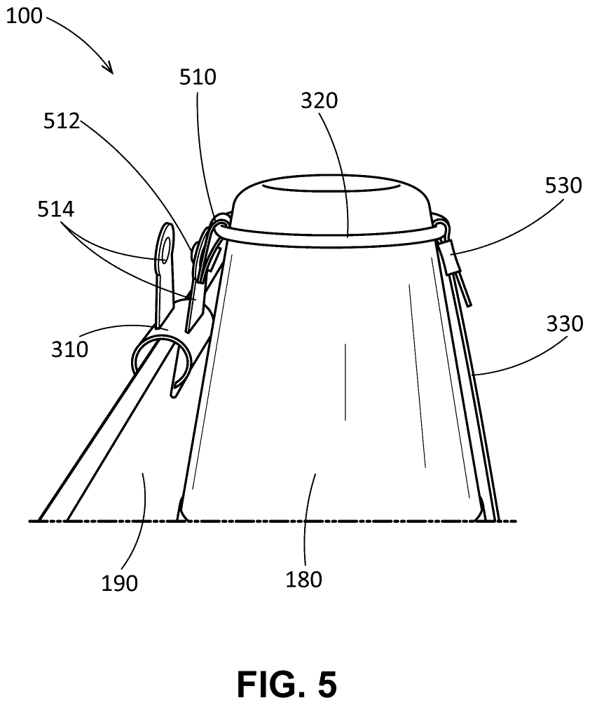

FIG. 5 is a detail view of the sign assembly 100 of FIG. 1, showing the top coupler 310 and the top ring 320.

In the aspect shown, the link 330 can be a wire rope, which can be looped around the top ring 320 and secured with a ferrule 530. In some aspects, the link 330 can be similarly coupled to the bottom ring 340 (shown in FIG. 4).

The top coupler 310 can be a clip, a clamp, or other suitable coupling mechanism capable of firmly connecting to the sign 190. In the aspect shown, the top coupler 310 can be a bulldog clip, for example and without limitation. In some aspects, the top coupler 310 can be a different type of coupler, such as a binder clip, spring clamp, alligator clip, or similar coupler. In the present aspect, a loop 510 can fit around the top ring 320 and couple to the top coupler 310 to secure the top coupler 310 to the top ring 320. In the aspect shown, the loop 510 can be secured to one of the ears 514 of the top coupler 310 with a fastener 512, such as a rivet, screw, bolt, nut, stud, or other suitable fastener. In some aspects, the top coupler 310 can be directly coupled to the top ring 320 with a technique such as welding, for example and without limitation. In some aspects, one of the ears 514 of the top coupler 310 can be bent around the top ring 320 to secure the top coupler 310 to the top ring 320.

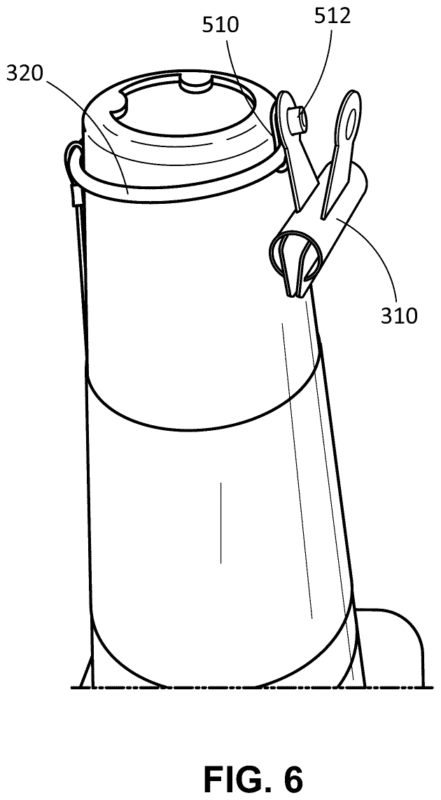

In the aspect shown, the loop 510 can hang downwards from the top ring 320 and couple to the top coupler 310. In the aspect shown in FIG. 6, the loop 510 can extend upwards from the top ring 320 and couple to the top coupler 310, which can accommodate a slightly taller sign 190 with the top ring 320 in the same position on the traffic cone 180. In some aspects, the top coupler 310 can be directly coupled to the top ring 320, such as through welding, bending the top coupler 310 around the top ring 320, or another suitable method.

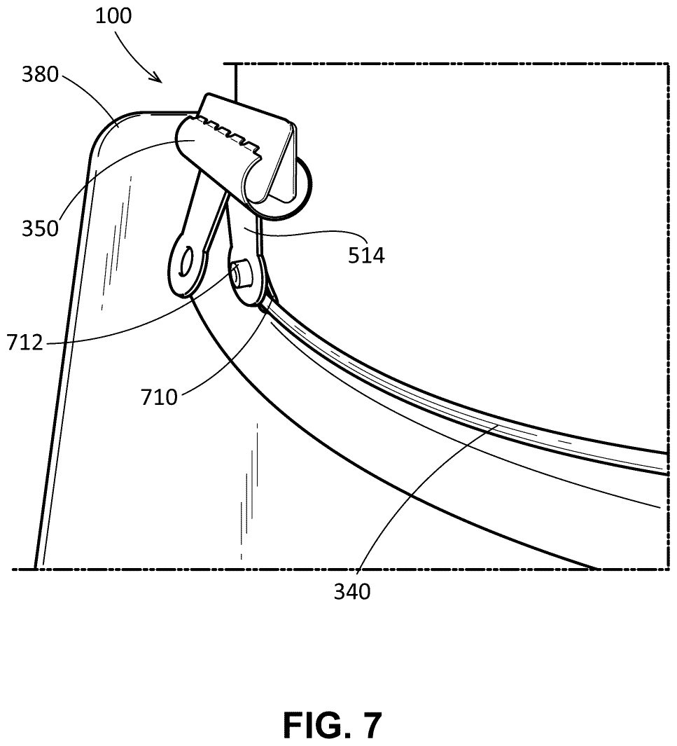

FIG. 7 is a detail view of the of the sign assembly 100 of FIG. 1, showing the bottom ring 340 and the bottom coupler 350. In the aspect shown, the bottom coupler 350 can be coupled to the bottom ring 340 with a loop 710 and a fastener 712, as similarly described above with respect to the top coupler 310 and top ring 320. The loop 710 can be positioned in an upward (shown) or downward orientation as described with respect to FIGS. 5-6. In some aspects, the bottom coupler 350 can be directly coupled to the bottom ring 340, such as through welding, bending the bottom coupler 350 around the bottom ring 340, or another suitable method.

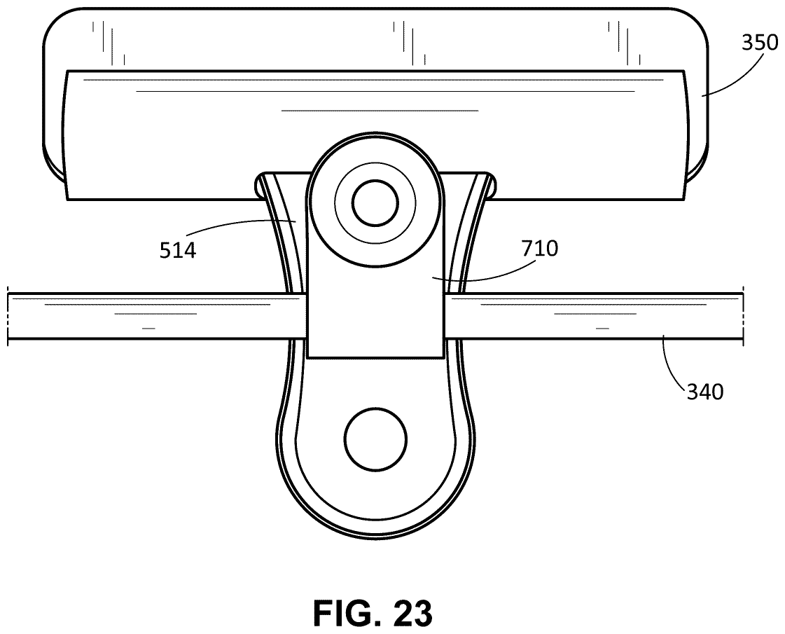

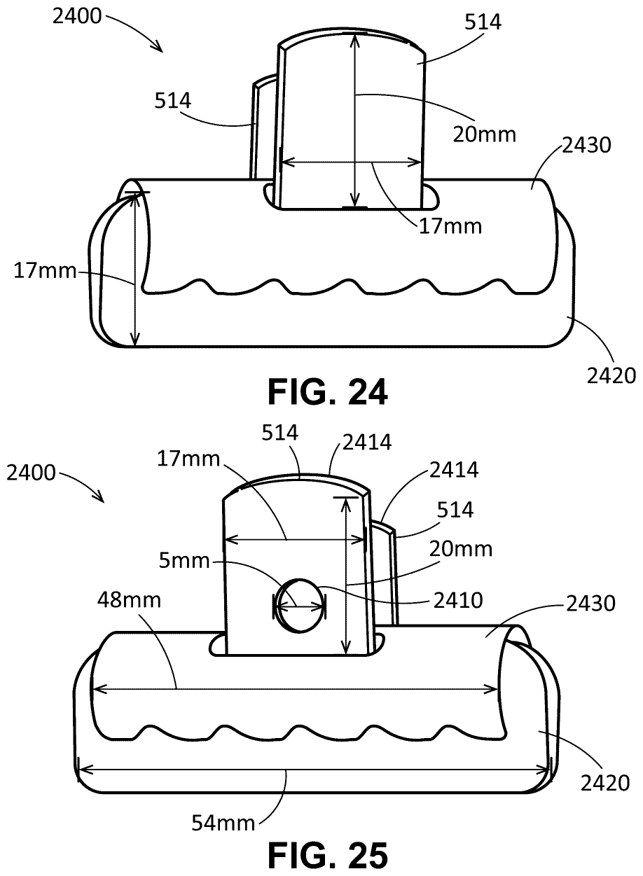

As described above with respect to the top coupler 310, in some aspects, the loop 710 can be coupled higher on the respective ear 514 to position the bottom coupler 350 lower relative to the bottom ring 340, as shown in FIG. 23. As shown, the ear 514 to which the loop 710 is attached can be shortened to avoid interference with the base 380 (shown in FIG. 7). In some aspects, both ears 514 can be shortened, as demonstrated in FIGS. 24-25.

FIG. 24 shows a front view of another aspect of a coupler 2400, which can be a top coupler 310 or a bottom coupler 350. FIG. 25 shows a rear view of the coupler 2400. As shown, the ears 514 of the coupler 2400 can be shortened compared to the ears 514 of the couplers 310,350 of FIG. 4. At least one ear 514 of the coupler 2400 can define a mounting hole 2410. In some aspects, the mounting hole 2410 can be positioned adjacent to the jaws 2420 of the coupler 2400. The jaws 2420 can be positioned opposite from the ends 2414 of the ears 514. In the aspect shown, the mounting hole 2410 can be positioned closer to the jaws 2420 than to the end 2414 of the respective ear 514 through which it is defined. The mounting hole 2410 can be utilized to attach the loop 510,710 or otherwise directly or indirectly couple the coupler 2400 to one of the rings 320,340. Utilizing shortened ears 514 and positioning the mounting hole 2410 near the jaws 2420 can reduce the extent to which coupler 2400 hangs below the bottom ring 340 when the coupler 2400 is utilized as a bottom coupler 350.

The couplers 310, 350, 2400 can comprise a biasing member 2430, which can fit over the jaws 2420 to bias the jaws 2420 together. In some aspects, the ears 514 can extend through the biasing member 2430. The dimensions shown for the coupler 2400 are exemplary and should not be viewed as limiting.

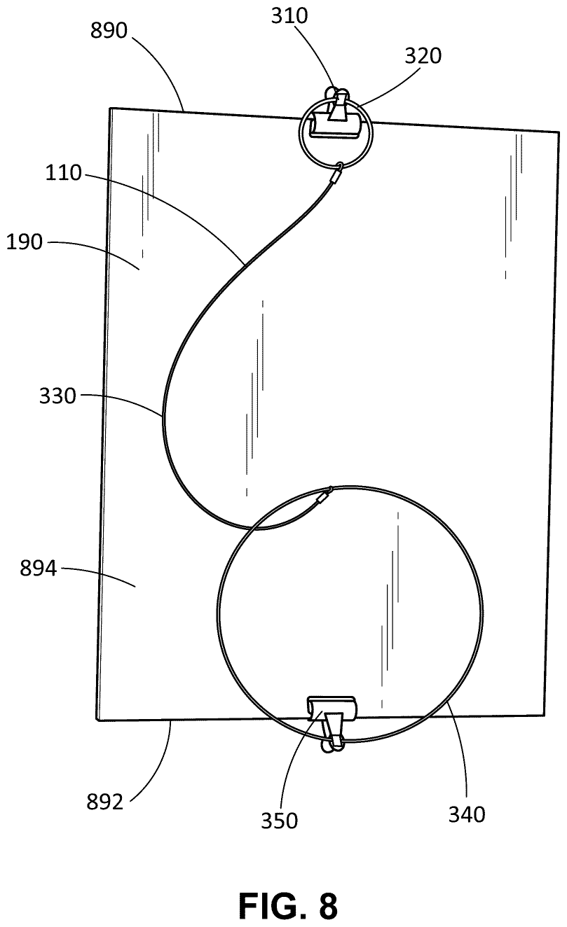

Returning to FIGS. 8-11, one exemplary method for installing the sign 190 and the mounting assembly 110 on the traffic cone 180 is depicted.

First, the mounting assembly 110 can be coupled to the sign 190, as shown in FIG. 8. The top coupler 310 can be coupled to a top end 890 of the sign 190 and the bottom coupler 350 can be coupled to a bottom end 892 of the sign 190 with a back surface 894 of the sign 190 facing the top ring 320, the link 330, and the bottom ring 340.

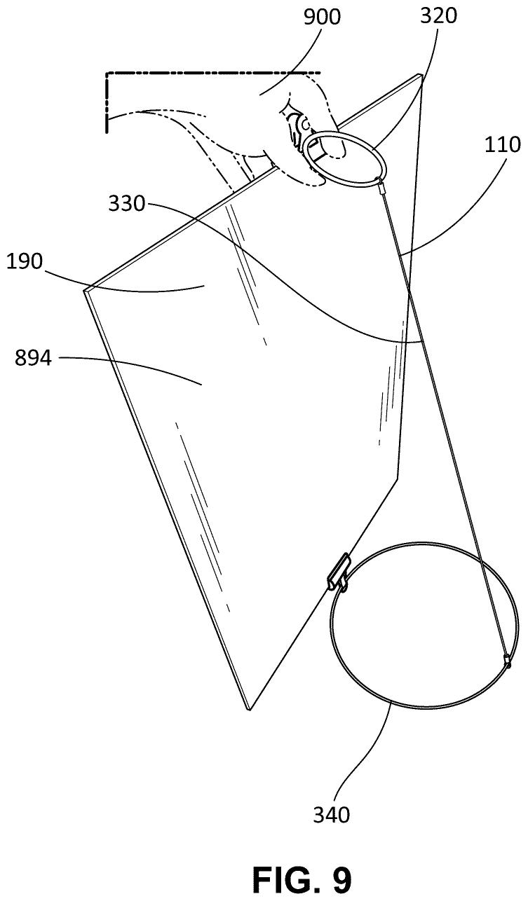

Next, a user 900 can pick up the sign 190 and the mounting assembly 110 with the top ring 320 extending outwards from the back surface 894 of the sign 190, as shown in FIG. 9. Positioning the top ring 320 to extend outwards from the back surface 894 can also position the bottom ring 340 to extend outwards from the back surface 894 due to the link 330, which can couple the top ring 320 and the bottom ring 340 together.

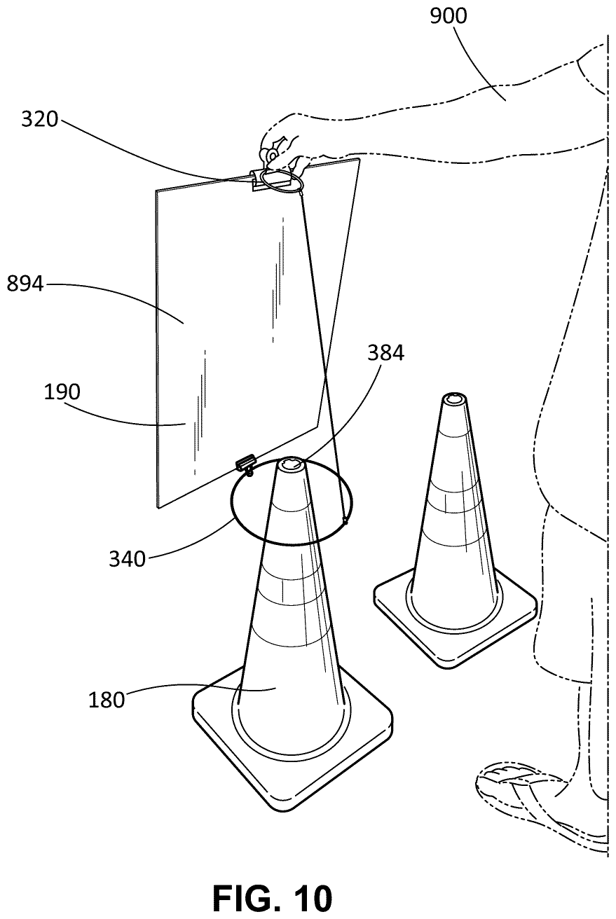

With the top ring 320 and bottom ring 340 extending outwards from the back surface 894 of the sign 190, the user 900 can lower the bottom ring 340 over the top end 384 of the traffic cone 180, as shown in FIG. 10.

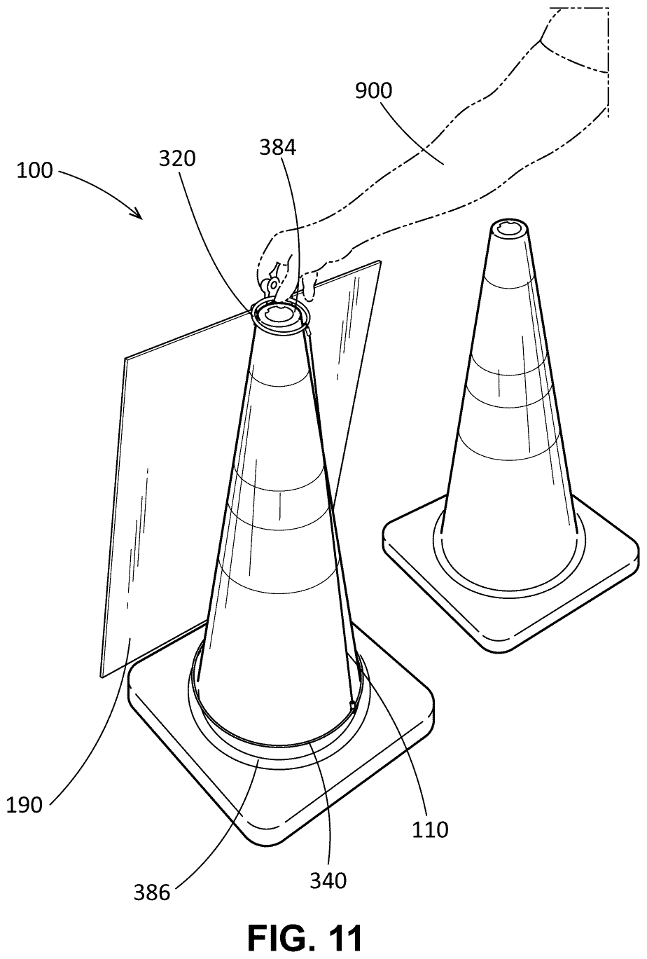

The user 900 can continue lowering the sign 190 and the mounting assembly 110 until the top ring 320 slips over the top end 384, as shown in FIG. 11, at which time the bottom ring 340 can be seated at or near the bottom end 386, thereby completing assembly of the sign assembly 100.

In some aspects, the mounting assembly 110 can be installed on the traffic cone 180 before coupling the sign 190 to the mounting assembly 110.

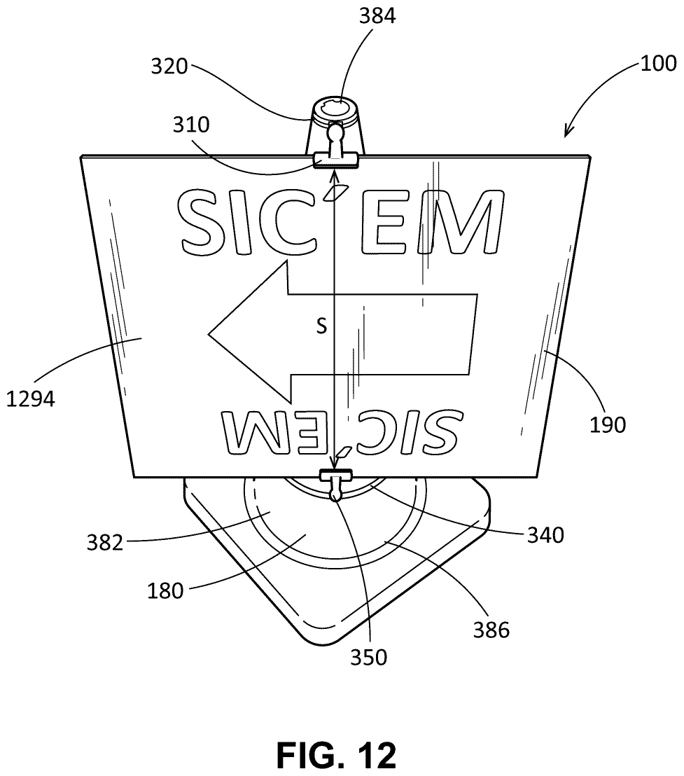

FIG. 12 is a front view of the sign assembly 100. The sign 190 can have a front surface 1294 positioned opposite from the back surface 894 (shown in FIG. 8). The sign 190 is shown positioned in a horizontal, or landscape, orientation rather than the vertical, or portrait, orientation shown in FIG. 11. In some aspects, the mounting assembly 110 can be reconfigurable to adjust a spacing S between the couplers 310,350, which can accommodate different orientations of the sign 190, or traffic cones 180 and/or signs 190 of varying dimensions or shapes.

For example and without limitation, the bottom ring 340 can be seated above the bottom end 386 of the conical portion 382 of the traffic cone 180 to reduce the spacing S. This can be accomplished by reducing the length L of the link 330 (length L of the link 330 shown in FIG. 3) and/or decreasing the inner diameter D2 of the bottom ring 340 (inner diameter D2 of the bottom ring 340 shown in FIG. 4) so the bottom ring 340 can rest higher on the conical portion 382. In some aspects, the link 330 can comprise webbing or a similar strap-like material with one or more buckles capable of reducing the length L of the link 330. In some aspects, the link 330 can feature a slip-knot which can be tightened or loosened to adjust its length L.

In some aspects, the top ring 320 can be positioned further below the top end 384 of the conical portion 382. This can be accomplished by increasing the internal diameter D1 of the top ring 320 (internal diameter D1 of the top ring 320 shown in FIG. 4) so that the top ring 320 can rest lower on the conical portion 382.

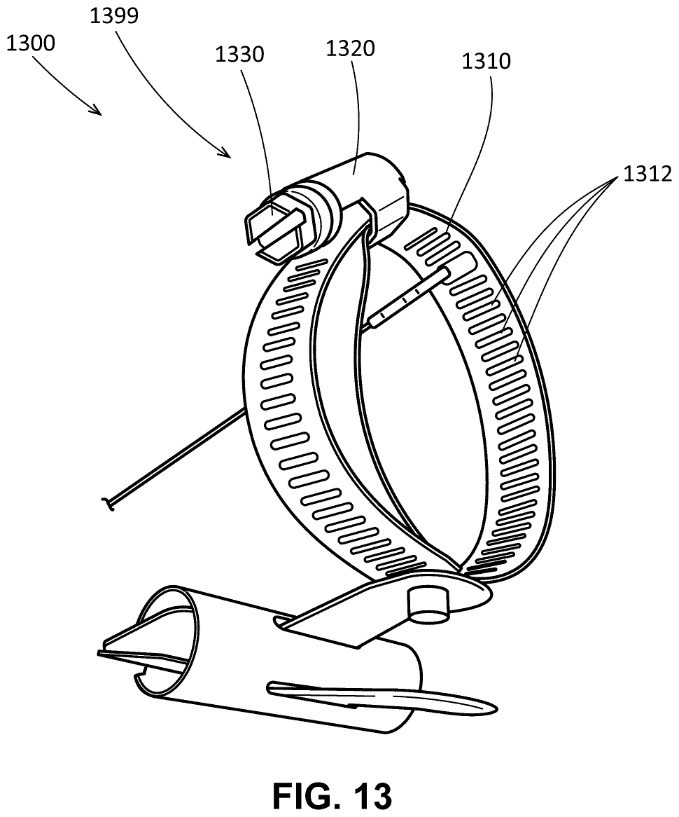

FIGS. 13-16 depict various aspects of an adjustable ring 1300, which can include an adjustment mechanism 1399. The adjustable ring 1300 can be used as the top ring 320 and/or the bottom ring 340 and can be adjusted to increase or decrease the respective internal diameters D1/D2.

For example, the aspect of the adjustable ring 1300 shown in FIG. 13 can comprise a band 1310, and the adjustment mechanism 1399 can be a worm gear 1320. The band 1310 can define a plurality of slots 1312, which can engage with an adjustment control 1330 of the worm gear 1320. Manipulation of the adjustment control 1330, such as by rotating the adjustment control 1330 for example and without limitation, can alter a circumference, and thus an internal diameter, of the adjustable ring 1300. For example and without limitation, the adjustable ring 1300 can be a worm gear hose clamp. In the aspect shown, the adjustment control 1330 can be configured to be adjusted with a tool, such as a wrench, screwdriver, or other suitable tool.

FIG. 14 depicts another aspect of the adjustable ring 1300, in which the adjustment mechanism 1399 can comprise an adjustment control 1330 that is configured to be adjusted by hand. For example and without limitation, the adjustment control 1330 can define a knob 1430, which can be grasped and turned by the user's fingers (not shown). In the aspect shown in FIG. 14, the worm gear 1320 can engage with a plurality of teeth 1412 of the band 1310 to adjust the circumference and inner diameter of the adjustable ring 1300.

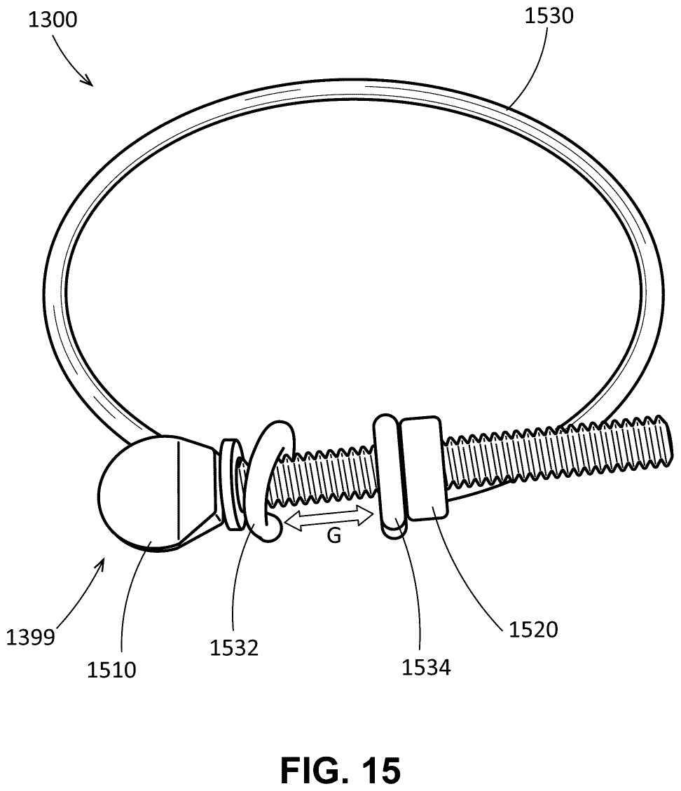

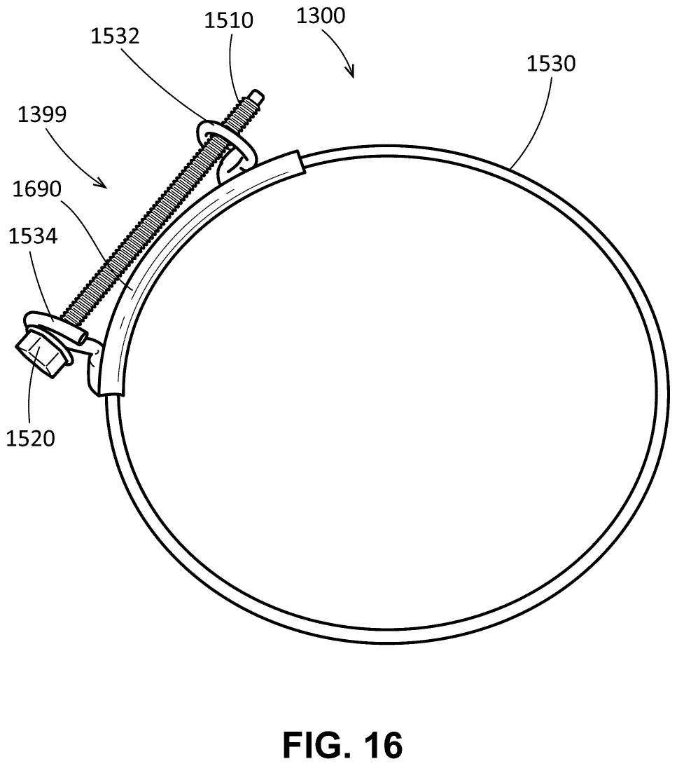

FIG. 15 and FIG. 16 depict additional aspects of the adjustable ring 1300. In the aspects shown, the adjustable mechanism 1399 can comprise a threaded fastener 1510 and a threaded member 1520, which can each be coupled to a split ring 1530. The threaded fastener 1510 can threadedly engage with the threaded member 1520. The threaded fastener 1510 can be fixed to a first end 1532 of the split ring 1530, and the threaded member 1520 can be fixed to a second end 1534 of the split ring 1530. By rotating the threaded fastener 1510 into or out from the threaded member 1520, a gap G between the ends 1532,1534 can be adjusted, which can change the circumference and inner diameter of the adjustable ring 1300.

In some aspects, the threaded member 1520 can be a nut, ferrule, insert, escutcheon, or another suitable threaded piece, for example and without limitation. In some aspects, the threaded fastener 1510 can be a bolt, screw, thumbscrew, or any other suitable type of fastener.

In the aspect of FIG. 15, the gap G can be exposed between the ends 1532,1534. In the aspect of FIG. 16, a bridge piece 1690 can extend across the gap G (shown in FIG. 15). The bridge piece 1690 can prevent pinching at the gap G when the adjustable ring 1300 is adjusted.

In some aspects, such as the top ring 320 of FIG. 17, the adjustable ring 1300 can exclude the adjustment mechanism 1399, and the split ring 1530 can resiliently expand from its original size, such as by elastically deforming and/or plastically deforming. For example and without limitation, the split ring 1530 can comprise a resilient material, such as spring steel or another suitable metal, plastic, an elastomer, or another suitable material.

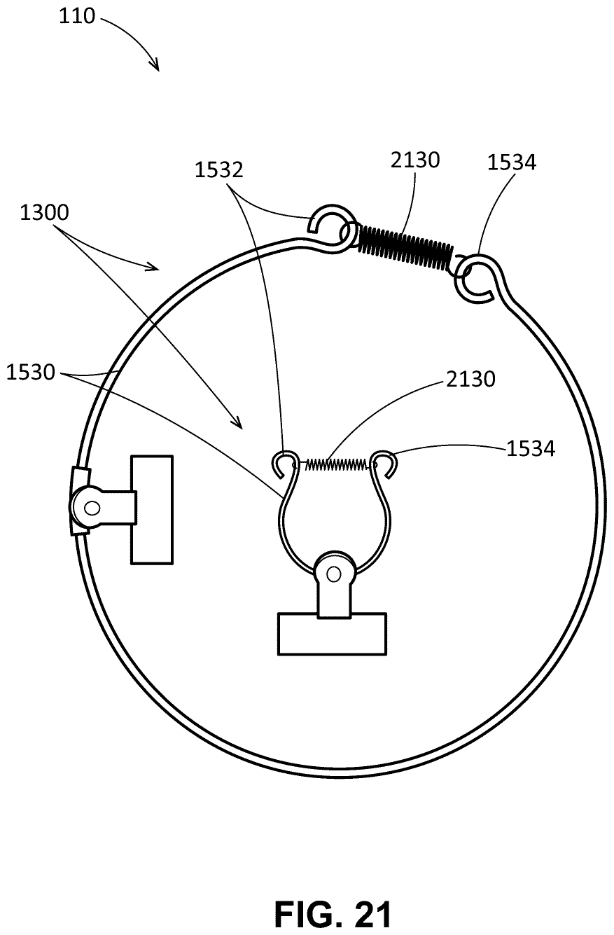

In some aspects, the adjustable ring 1300 can include a biasing member 2130, as demonstrated by the aspect of the mounting assembly 110 shown in FIG. 21. In the aspect shown, the first end 1532 and/or the second end 1534 can each form a loop, hook, eyelet, or other suitable structure. The biasing member 2130 can be coupled to the first end 1532 and the second end 1534. The biasing member 2130 can exert a biasing force that pulls the ends 1532,1534 towards each other. The biasing member 2130 and the biasing force can resist stretching the adjustable ring 1300 to a larger internal diameter and aid the adjustable ring 1300 in clamping onto the traffic cone 180 (shown in FIG. 12) when stretched over a larger portion of the traffic cone 180. In some aspects, the biasing member 2130 can be a spring, such as an extension spring, torsion spring, spiral spring, leaf spring, garter spring, or any other suitable type of spring. In some aspects, the biasing member 2130 can comprise an elastomer, such as an elastic, rubber, or polymer member, for example and without limitation.

In some aspects, the biasing member 2130 can be used with flexible or pliable materials for the split ring 1530. For example and without limitation, the biasing member 2130 can be used with an aspect of the split ring 1530 that comprises rope, a strap, a band, webbing, string, or other another suitable material. In some aspects, the biasing member 2130 can be used with a split ring 1530 that comprises a rigid and resilient material, such as where the split ring 1530 comprises metal, a polymer, or other suitable material. In such aspects, the biasing member 2130 can cooperate with the resiliency of the split ring 1530 to return the adjustable ring 1300 to its original shape after being stretched to a larger internal diameter.

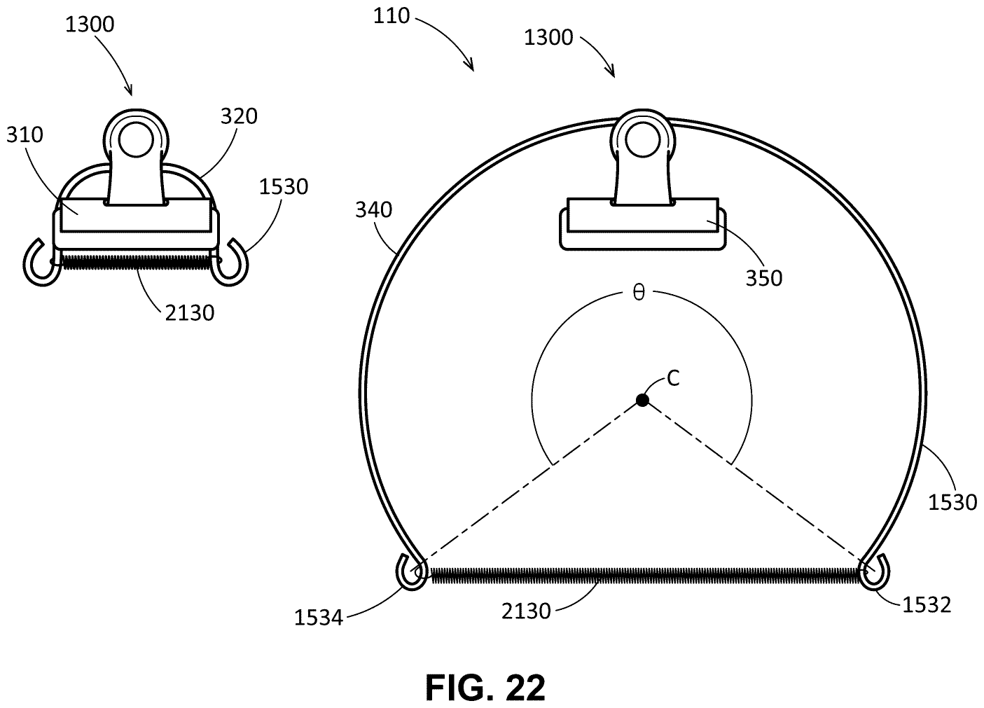

FIG. 22 shows additional aspects of the top ring 320 and the bottom ring 340 of the mounting assembly 110. As demonstrated by the bottom ring 340, the split ring 1530 can be formed substantially as an arc of a circle, though this shape should not be viewed as limiting. In the aspect shown, point C can represent a center of the split ring 1530, and angle θ can represent a central angle corresponding to the arc of the split ring 1530, as measured from the centers of the loops at ends 1532,1534. In some aspects, the angle θ can be between 180° and 360°. In some aspects, the angle θ can be between 200° and 340°. In some aspects, the angle θ can be between 220° and 320°. In some aspects, the angle θ can be between 240° and 300°. In some aspects, the angle θ can be between 260° and 280°.

In some aspects, the angle θ can be less than 180°. In some aspects, the adjustable ring 1300 can be primarily defined by the biasing member 2130. In some aspects, the central angle θ of the split ring 1530 can be between 0° and 180°. In some aspects, the angle θ can be between 20° and 160°. In some aspects, the angle θ can be between 40° and 140°. In some aspects, the angle θ can be between 60° and 120°. In some aspects, the angle θ can be between 80° and 100°.

In some aspects, the adjustable ring 1300 can be formed by a loop-shaped biasing member 2130 (such as a garter spring or other suitable type of spring, for example and without limitation). In such aspects, the adjustable ring 1300 may exclude the split ring 1530. In some aspects, the coupler 310,350 can be coupled to the biasing member 2130 of the respective top or bottom adjustable ring 1300.

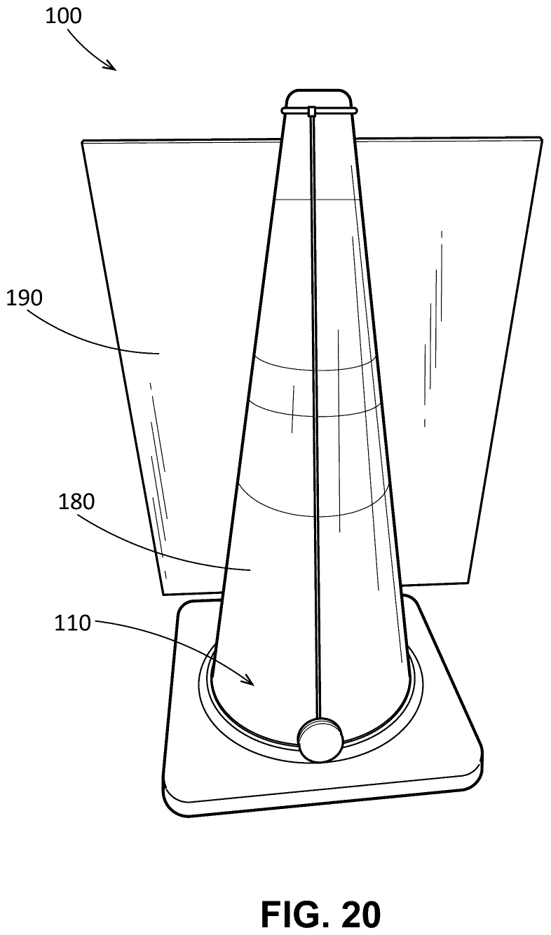

FIGS. 17-20 show another aspect of the mounting assembly 110 and another exemplary method for installing the sign 190 (shown in FIG. 20) and the mounting assembly 110 on the traffic cone 180. The disclosed method can also be used with other disclosed aspects of the mounting assembly 110.

As shown in FIG. 17, the link 330 can be a retractable link 1730. For example and without limitation, the retractable link 1730 can be a retractable lanyard or other suitable retraction mechanism. The retractable link 1730 is shown in its retracted configuration in FIG. 17, which positions the rings 320,340 in close proximity to one another. In the retracted configuration, the potential for multiple mounting assemblies 110 to become entangled with one another can be minimized.

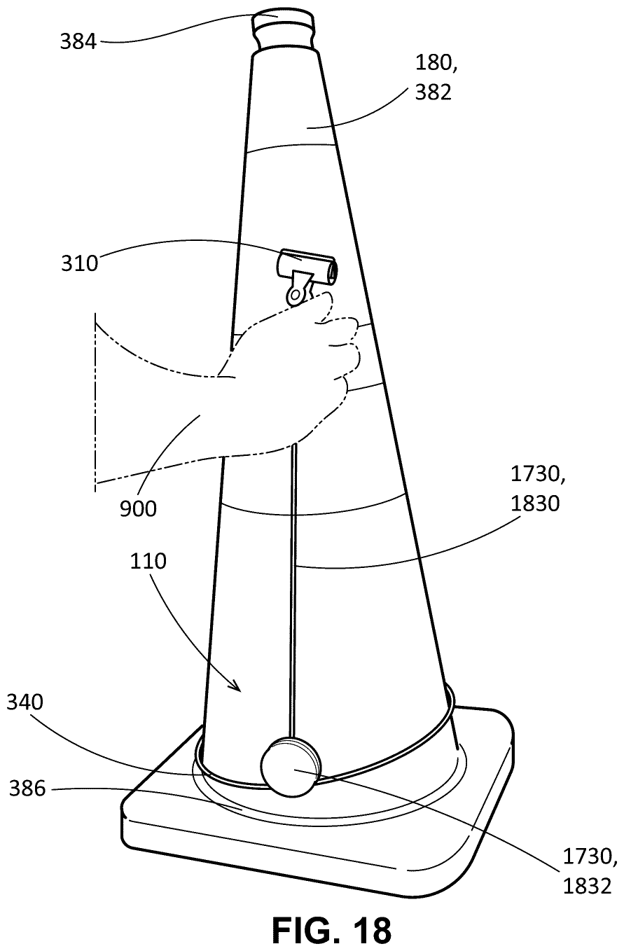

To install the mounting assembly 110 on the traffic cone 180, the user 900 can place the bottom ring 340 over the conical portion 382 of the traffic cone 180 so that the bottom ring 340 is positioned at or near the bottom end 386, as shown in FIG. 18.

The user 900 can then pull the top coupler 310 and/or top ring 320 (shown in FIG. 17) upwards towards the top end 384, which can draw a link 1830 of the retractable link 1730 outwards from a housing 1832 of the retractable link 1730. In some aspects, the housing 1832 can comprise a biasing mechanism, such as a spring for example and without limitation, which can exert a force to retract the link 1830 into the housing 1832. In some aspects, the retracting force can be a constant force. In some aspects, the retractable link 1730 can comprise a locking mechanism, such as a ratcheting mechanism for example and without limitation, that can secure the link 1830 at one or more set lengths and can be disengaged by releasing the locking mechanism, thereby allowing the link 1830 to retract. In some aspects, housing 1832 may not exert a biasing force. For example and without limitation, the retractable link 1730 can have a reeling mechanism to retract, or reel, the link 1830 into the housing 1832.

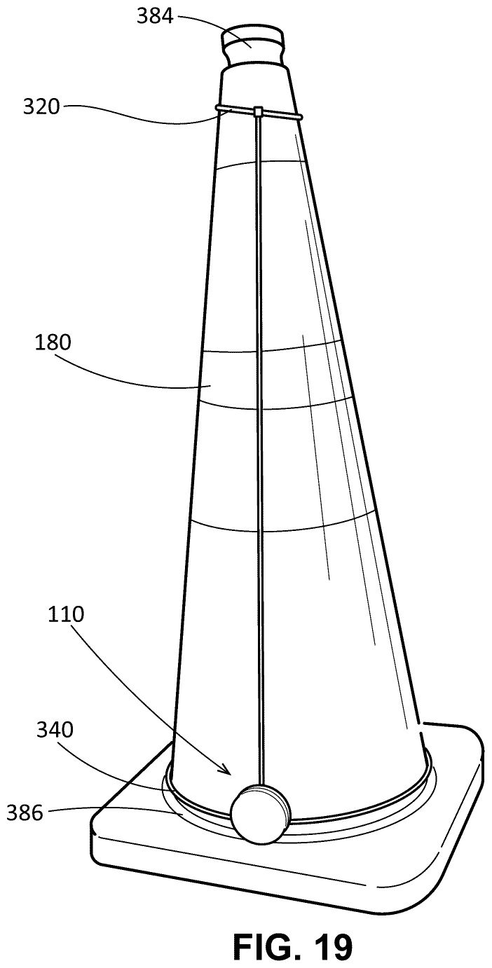

With the retractable link 1730 in an extended configuration, the top ring 320 can be placed over the top end 384 of the traffic cone 180, as shown in FIG. 19, which can complete installation of the mounting assembly 110 on the traffic cone 180. In some aspects, the installation can proceed in reverse order, wherein both the top ring 320 and the bottom ring 340 are placed over the top end 384, and the bottom ring 340 can then be pulled downwards towards the bottom end 386.

With the mounting assembly 110 installed on the traffic cone 180, as shown in FIG. 20, the sign 190 can then be coupled to the couplers 310,350 (shown in FIG. 17) to complete assembly of the sign assembly 100. In some aspects, the aspect of the mounting assembly 110 shown in FIG. 17 can be coupled to the sign 190 before installing the mounting assembly 110 on the traffic cone 180, as similarly discussed above with respect to FIGS. 7-11.

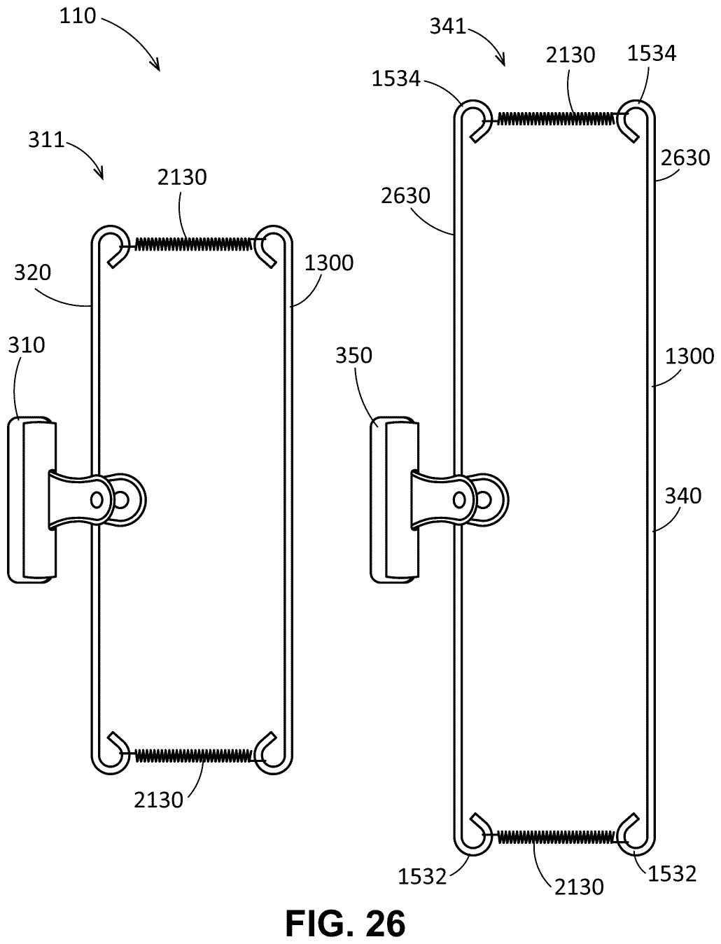

FIG. 26 shows additional aspects of the top coupling ring 311 and the bottom coupling ring 341 of the mounting assembly 110. In the aspect shown, the top ring 320 and the bottom ring 340 can be adjustable rings 1300. In some aspects, the rings 320,340 can comprise a plurality of biasing members 2130. In some aspects, the rings 320,340 can comprise a plurality of ring segments 2630. The plurality of biasing members 2130 can be coupled to the ends 1532,1534 of the ring segments 2630, which can couple the ring segments 2630 together. In some aspects, two ring segments 2630 can be coupled directly together. For example and without limitation, the first ends 1532 can be coupled directly together and a biasing member 2130 can extend between the second ends 1534. In such aspects, the first ends 1532 can form a hinge. The couplers 310,350 can be respectively coupled to one of the ring segments 2630 or one of the biasing members 2130 of the rings 320,340 in various aspects.

The various aspects of rings 320,340 disclosed herein can be utilized together in different combinations. In some aspects, the rings 320,340 can differ in construction from one another. As one nonlimiting example, the top ring 320 can be a rigid, one-piece ring, and the bottom ring 340 can be an adjustable ring 1300, which can comprise one or more biasing members 2130, ring segments 2630, and/or adjustment mechanisms 1399 in various nonlimiting aspects.

In the aspect shown, the ring segments 2630 can be shaped to fit upon a pyramidal traffic cone, as shown in FIGS. 27 and 28. The ring segments 2630 can comprise substantially straight portions between the ends 1532,1534, and the ends 1532,1534 can each optionally form a loop, hook, eyelet, or other suitable structure for coupling to the biasing members 2130. In some aspects, one or more of the ring segments 2630 can be substantially U-shaped.

In some aspects, the ring segments 2630 can be shaped to fit upon a different type of traffic cone, such as the conical traffic cone shown in FIG. 1. For example and without limitation, a plurality of curved ring segments 2630 can be coupled together by a plurality of biasing members 2130.

FIGS. 27-29 demonstrate methods for mounting the sign 190 on the traffic cone 180 utilizing the adjustable rings 1300 of FIG. 26. As shown in FIG. 27, the upright portion 381 of the traffic cone 180 can be a pyramidal portion 2782. The traffic cone 180 of FIG. 27 can be what is sometimes referred to as a “panel cone,” “vertical panel,” or “traffic panel.”

As shown in FIG. 27, the top coupling ring 311 and the bottom coupling ring 341 can first be placed over the top end 384 of the traffic cone 180 and slid down the upright portion 381. The sign 190 can then be coupled to the couplers 310,350 as shown in FIG. 28.

As demonstrated by FIG. 29, the top coupling ring 311 and the bottom coupling ring 341 can first be coupled to the sign 190, and then the bottom ring 340 and subsequently the top ring 320 can be lowered over the top end 384 of the traffic cone 180 and down the upright portion 381 to secure the sign 190 to the traffic cone 180.

One should note that conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more particular embodiments or that one or more particular embodiments necessarily include logic for deciding, with or without user input or prompting, whether these features, elements and/or steps are included or are to be performed in any particular embodiment.

It should be emphasized that the above-described embodiments are merely possible examples of implementations, merely set forth for a clear understanding of the principles of the present disclosure. Any process descriptions or blocks in flow diagrams should be understood as representing modules, segments, or portions of code which include one or more executable instructions for implementing specific logical functions or steps in the process, and alternate implementations are included in which functions may not be included or executed at all, may be executed out of order from that shown or discussed, including substantially concurrently or in reverse order, depending on the functionality involved, as would be understood by those reasonably skilled in the art of the present disclosure. Many variations and modifications may be made to the above-described embodiment(s) without departing substantially from the spirit and principles of the present disclosure. Further, the scope of the present disclosure is intended to cover any and all combinations and sub-combinations of all elements, features, and aspects discussed above. All such modifications and variations are intended to be included herein within the scope of the present disclosure, and all possible claims to individual aspects or combinations of elements or steps are intended to be supported by the present disclosure.

That which is claimed is:

1. A sign assembly comprising:
a traffic cone;
a sign; and
a mounting assembly comprising:
a top coupler coupled to the sign;
a top ring coupled to the top coupler, the top ring positioned around an upright portion of the traffic cone;
a bottom coupler coupled to the sign; and
a bottom ring coupled to the bottom coupler, the bottom ring positioned around the upright portion.

2. The sign assembly of claim 1, wherein the mounting assembly further comprises a link coupled to the top ring and to the bottom ring.

3. The sign assembly of claim 2, wherein the link is coupled to the top ring opposite from the top coupler.

4. The sign assembly of claim 2, wherein the link is rigid.

5. The sign assembly of claim 2, wherein the link is flexible.

6. The sign assembly of claim 2, wherein the link is configured to automatically retract.

7. The sign assembly of claim 1, wherein at least one of the top ring and the bottom ring is rigid.

8. The sign assembly of claim 1, wherein at least one of the top ring and the bottom ring is flexible.

9. The sign assembly of claim 1, wherein the upright portion is a conical portion.

10. The sign assembly of claim 1, wherein the upright portion is a pyramidal portion.

11. The sign assembly of claim 10, wherein the traffic cone is a traffic panel.

12. A mounting assembly for mounting a sign to a traffic cone, the mounting assembly comprising:
a first coupler configured to couple to the sign;
a first ring coupled to the first coupler, the first ring sized to fit around an upright portion of the traffic cone;
a second coupler configured to couple to the sign; and
a second ring coupled to the second coupler, the second ring sized to fit around the upright portion.

13. The mounting assembly of claim 12, wherein the first ring comprises a biasing member.

14. The mounting assembly of claim 12, wherein the first ring comprises a plurality of ring segments.

15. The mounting assembly of claim 14, wherein a first ring segment of the plurality of ring segments is coupled to a second ring segment of the plurality of ring segments by a biasing member of the first ring.

16. The mounting assembly of claim 12, wherein at least one of the first ring is an adjustable ring.

17. The mounting assembly of claim 16, wherein the adjustable ring comprises an adjustment mechanism.

18. The mounting assembly of claim 12, wherein the upright portion is a conical portion of the traffic cone.

19. The mounting assembly of claim 12, wherein the upright portion is a pyramidal portion of the traffic cone.

20. The mounting assembly of claim 19, wherein the traffic cone is a traffic panel.
